(19) United States
(12) Patent Application Publication
(10) Pub. No.: US 2018/0232776 A1
(43) Pub. Date: Aug. 16, 2018

(54) PERSONALIZED ADVERTISING SYSTEM

(71) Applicant: Linctronix Ltd., New Taipei City (TW)

(72) Inventors: Yu-Shun Lin, New Taipei City (TW); Kuei-Han Chen, New Taipei City (TW)

(21) Appl. No.: 15/896,311

(22) Filed: Feb. 14, 2018

(30) Foreign Application Priority Data
Feb. 15, 2017 (TW) 106104834

(51) Int. Cl. G06Q 30/02; G06N 99/00; H04L 29/12; H04W 4/02

(52) U.S. Cl. CPC G06Q 30/0269; G06Q 30/0267; G06Q 30/0261; H04W 4/02; G06N 99/005; H04L 61/6022; G06Q 30/0255

(57) ABSTRACT

A personalized advertising system for sending personalized advertisements to a user comprises a positioning device, a track database, a customer database, a preference learning module and a personalized advertising module. The positioning device calculates a moving trajectory according to the wireless signal sent by a mobile device of the user and stores the moving trajectory in the track database. The customer database stores a shopping profile of the user. The preference learning module generates a predicted shopping preference information for the user according to the moving trajectory and the shopping profile. The personalized advertising module sends a personalized advertising message to the user according to the predicted shopping preference information. Compared with the prior art, the system of the present invention utilizes the location tracking technology to detect the behavior of the user in the store, and sends the appropriate advertisements to the user by automatic preference learning.

### CROSS-REFERENCE TO RELATED APPLICATIONS

This application claims the priority benefit of Taiwan Application Serial No. 106104834 filed Feb. 15, 2017 the disclosure of which is incorporated herein by reference.

### FIELD OF THE INVENTION

The present invention relates to a personalized advertising system, more particularly, to a personalized advertising system detecting the customer activity in the store by position tracking technology, learning the shopping preference of the customer from moving trajectory and shopping record of the customer, and selecting the advertisements or the promotion according to the preference of the customer, and then sending the advertisements or the promotion to the customer.

### DESCRIPTION OF THE PRIOR

In recent years, the network industry develops quickly. More and more people understand the impact of the network and the potential of the online market. Thus, it results in the rapid expansion of the network marketing. It's easy to be noticed by consumers that the way of network marketing is changing. In the past, most of the ads on the network are selected and displayed randomly, so that usually the consumers are not interested in the content of ads. The way of shooting a target in the dark not only causes the inefficient advertising, but also wasting lots of resources. Recently, network advertisers have consistently improved the way of advertising to avoid inefficient advertising. Nowadays the network advertisements often make consumers feel like “It is just what I need”. For example, the girl who likes the Korean products could see the ads of Korean products on the community sites she used frequently. Because the network marketing uses a preference learning technology, consumers will have such a feeling. The preference learning technology can be used to calculate the shopping preferences of the user according to the user's habit of browsing the web, such as web pages often viewed, keywords often used, or frequently items often purchased. According to the shopping preferences, the preference learning technology selects the ads that the user may be interested in and sends the selected ads to the web pages often viewed by the user. Combined with preference learning technology not only saves the cost of network marketing, but also greatly improves the marketing results.

However, despite the gradual expansion of the network marketing, physical marketing is still an essential part of human life. The advantages of physical marketing such as the relationship between people, the atmosphere of the scene, or the actual contact with the feeling of goods could not be completely replaced by network marketing. Therefore, how to effectively combine the preference learning technology used in network marketing and the advantage of physical marketing becomes a problem to be solved by the present invention.

### SUMMARY OF THE INVENTION

The objective of the present invention is to provide a personalized advertising system, for sending a personalized advertisement to a mobile device that is carried by a consumer when entering a space.

In an embodiment, the personalized advertising system of the present invention comprises a positioning device, a track database, a customer database, a preference learning module, and a personalized advertising module. When a user carries the mobile device into a space that is deployed with the positioning device, the positioning device receives a wireless signal including a MAC address transmitted by the mobile device. And then, the positioning device obtains at least one position of the mobile device in the space according to the wireless signal and calculates a moving trajectory according to at least one position. The track database is connected to the positioning device and is used for receiving and storing the moving trajectory calculated by the positioning device. The customer database is connected to the positioning device and is used for storing the MAC address of the mobile device and a shopping profile corresponding to the MAC address. The preference learning module is connected to the track database and the customer database to receive the moving trajectory and the shopping profile. The preference learning module predicts a suggested shopping preference information of the user according to the moving trajectory and the shopping profile. The personalized advertising module is connected to the preference learning module to receive the predicted shopping preference information. Then the personalized advertising module sends a personalized advertisement to the mobile device of the user according to the predicted shopping preference information.

In another embodiment, the position device of the personalized advertising system of the present invention further comprises a plurality of wireless signal receivers and a positioning server. The plurality of wireless signal receivers are set up in the space respectively, and are used for receiving the wireless signal from the mobile device and transmitting a wireless positioning signal respectively. Wherein, the wireless positioning signal comprises the MAC address of the wireless signal and a wireless signal strength indicator data of the wireless signal. The positioning server is used for receiving the wireless positioning signals, and calculating the at least one position of the mobile device according to the set up position of the wireless signal receivers and the wireless positioning signals.

In another embodiment, the personalized advertising module of the personalized advertising system of the present invention further comprises an advertisement sending channel management unit and an electronic ticket unit. The advertisement sending channel management unit obtains a social media often used by the user via the shopping profile, and then sends the personalized advertising message to the user via the social media according to the predicted shopping preference information generated by the preference learning module. The electronic ticket unit sends the personalized advertising message comprising a related electronic coupon to the user according to the predicted shopping preference information generated by the preference learning module.

In another embodiment, the customer database of the personalized advertising system of the present invention is connected to a merchant checkout system, the merchant checkout system stores a trade record and a coupon used record of the user in the shopping profile of the customer database. And the customer database further stores usage data of electronic coupons used by consumers.

Compared to the prior art, the personalized advertising system of the present invention detects the customer activity in the store by the positioning device. Then the personalized advertising system sends advertisements or coupons of merchants via an appropriate channel according to the track databases, consumer databases and the suggestion from the preference learning module. Compared to the formerly physical marketing, the personalized advertising system of the present invention sends the advertisement that the user may be interested in according to the different shopping habits of each user. The personalized advertising system also learns preference of each consumer according to the reaction from consumers against each advertisement in turns to achieve more efficient advertising.

### BRIEF DESCRIPTION OF THE APPENDED DRAWINGS

Some of the embodiments will be described in detail, with reference to the following figures, wherein like designations denote like members, wherein:

FIG. 1 shows a functional block diagram of the embodiment of the personalized advertising system of the present invention.

FIG. 2 shows a schematic diagram of the positioning device in FIG.1.

FIG. 3 shows a functional block diagram of the embodiment of the personalized advertising module of the personalized advertising system of the present invention.

The advantages, spirits, and features of the present invention will be explained and discussed with embodiments and figures as follows

### DETAILED DESCRIPTION OF THE INVENTION

A detailed description of the hereinafter described embodiments of the disclosed apparatus and method are presented herein by way of exemplification and not limitation with reference to the Figures. Although certain embodiments are shown and described in detail, it should be understood that various changes and modifications can be made without departing from the scope of the appended claims. The scope of the present invention will in no way be limited to the number of constituting components, the materials thereof, the shapes thereof, the relative arrangement thereof, etc., and are disclosed simply as an example of embodiments of the present invention.

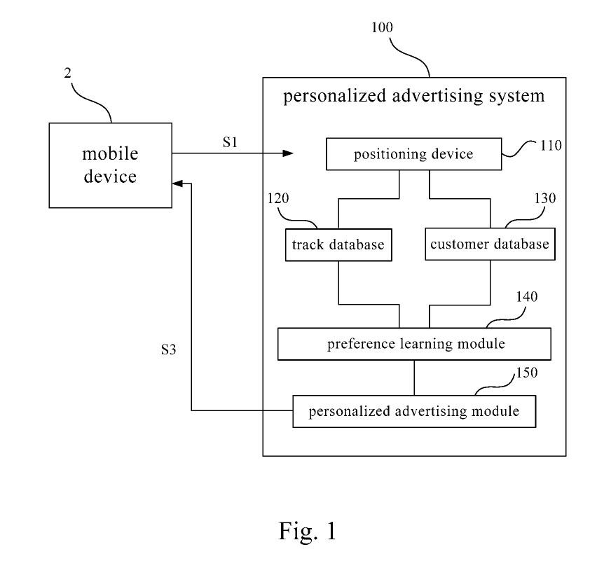

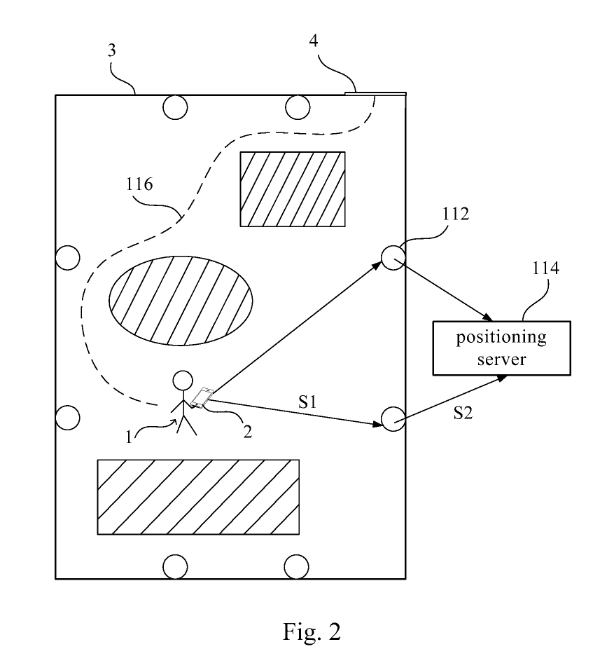

Please refer to FIG. 1 and FIG. 2. FIG. 1 shows a functional block diagram of the embodiment of the personalized advertising system 100 of the present invention. FIG. 2 shows a schematic diagram of the positioning device 110 in FIG. 1. As shown in FIG. 1 and FIG. 2, in an embodiment, the personalized advertising system 100 sends a personalized advertisement to a mobile device 2 when a user 1 carries the mobile device 2 and enters into a space 3. The personalized advertising system 100 comprises a positioning device 110, a track database 120, a customer database 130, a preference learning module 140, and a personalized advertising module 150. When the mobile device 2 enters into a space 3 which is deployed with positioning device, the positioning device 110 receives a wireless signal S1 including a MAC address transmitted by the mobile device 2. And then, the positioning device 100 obtains at least one position of the mobile device 2 in the space 3 according to the wireless signal S1, and calculates a moving trajectory 116 of the user 1 and the mobile device 2 according to at least one position. The track database 120 is connected to the positioning device 110. The track database 120 is used for receiving and storing the moving trajectory 116 calculated by the positioning device 110. The customer database 130 is connected to the positioning device 110. The customer database 130 is used for storing the MAC address of the mobile device 2 and a shopping profile corresponding to the MAC address. The preference learning module 140 is connected to the track database 120 and the customer database 130 to receive the moving trajectory 116 and the shopping profile. The preference learning module 140 predicts a suggested shopping preference information of the user 1 according to the moving trajectory 116 and the shopping profile. The personalized advertising module 150 is connected to the preference learning module 140 to receive the suggested shopping preference information. Then the personalized advertising module 150 sends a personalized advertisement message S3 to the mobile 2 of the user 1 according to the suggested shopping preference information.

Wherein, the positioning device 110 further comprises a plurality of wireless signal receivers 112 and a positioning server 114. The plurality of wireless signal receivers 112 are set up in the space 3 respectively. The plurality of wireless signal receivers 112 receive the wireless signal S1 and calculate the strength indicator of the wireless signal S1. Then the plurality of wireless signal receivers 112 transmit a wireless positioning signal S2 respectively. Wherein, the wireless positioning signal S2 comprises the MAC address of the wireless signal S1 and a wireless signal strength indicator data of the wireless signal. The positioning server 114 is used for receiving the wireless positioning signals S2 and calculating the position of the mobile device 2 according to the position of the wireless signal receivers 112 and the wireless positioning signals S2. In practice, the positioning method of the positioning device 110 is selected from at least one of following positioning technology: Infrared positioning technology, ultrasonic positioning technology, RFID positioning technology, Bluetooth positioning technology, Wi-Fi positioning technology, ZigBee positioning technology, ultra wideband positioning technology, and GPS positioning technology.

In practice, the above-mentioned space 3 may be a shop, a restaurant, a department store, or a shopping mall. When a user 1 carries the mobile device 2 and enters a space 3, the wireless network of the mobile device 2 performs a signal scan or an endpoint communication. At the same time, ISM (Industrial Scientific Medical Band) sends multiple wireless signals S1. Every wireless signal S1 comprises MAC address of the mobile device 2 at least. The plurality of wireless signal receivers 112 located at certain position in space 3 receives the wireless signal S1 from ISM. The wireless signal receivers 112 obtain the MAC address in the wireless signal S1 and calculate the RSSI (Received Signal Strength Indication) of the wireless signal S1. The wireless signal receiver 112 can transmit the wireless positioning signals S2 by internet or enterprise intranet network. The wireless positioning signals S2 comprise the MAC address of the wireless signal S1 and the RSSI of the wireless signal S1. Besides, the wireless positioning signals S2 can further comprise the position information of the wireless signal receiver 112. The position information can be represented as a coordinate address, a vector address, or a location code. The location code is a code with a table look-up mechanism or a formula conversion mechanism to obtain the coordinate address or the vector address. The positioning server 114 compares the position information with data stored at a certain position database to obtain the certain position of the wireless signal receiver 112 in space 3.

The positioning server 114 receives the wireless positioning signals S2 by internet or enterprise intranet network. The distance between mobile device 2 and the wireless signal receiver 112 which is fixed at certain position is inversely proportional to the RSSI of the wireless signal S1. Therefore, the position of the mobile device 2 in the space 3 can be calculated by the positioning algorithm. Wherein, the positioning algorithm may mark out a circle as a positioning area, and a single dot is used to mark the center and a distance is used to mark the radius; or the positioning algorithm may use two points and their distances to mark two circles, and the intersection with shuttle shape will be the positioning area; or the positioning algorithm may use three points to perform trilateration positioning or triangle positioning, and three dots are used to mark the center and three distances are used to mark the radius, and the intersection of three circles will be the positioning area; moreover, cellular algorithms is used to calculate the positioning area having a maximum overlapping of multiple triangles.

The positioning device 110 may continuously calculate the position of the mobile device 2 according to the wireless signal S1 sent from the mobile device 2. The positioning device 110 calculates the moving trajectory 116 from multiple sequential position calculations. In order to increase the accuracy and reduce the noise of the moving trajectory 116, the positioning device 110 may set a trajectory start condition. The trajectory start condition can be a trajectory start position, such as an entrance of the space 3, a front door 4, a passage, an area, a specific place, a specific line, or a floor. When the mobile device 2 passes through or at the trajectory start position and has not yet started recording, the moving trajectory 116 starts recording. The positioning device 110 may set a trajectory stop condition. The trajectory stop condition can be a trajectory stop position, such as an exit, a front door 4, a checkout counter, a passage, an area, a specific place, a specific line, or a floor. The trajectory stop condition also can be a trajectory stop time, such as 30 minute, 60 minute. Furthermore the trajectory stop condition may be a time after receiving the latest wireless signal S1 of the mobile device 2 such as 1 minute, 3 minute, or 5 minute after receiving the latest wireless signal S1 of the mobile device 2.

The moving trajectory 116 is stopped when the trajectory stop condition is matched. The positioning device 110 transmits the moving trajectory 116 to the track database 120 to be stored. Wherein, the moving trajectory 116 comprises a recording start time, a recording stop time, position staying time, and MAC address corresponding to the mobile device 2. On the other hand, the positioning device 110 stores the MAC address of the mobile device 2 in the customer database 130. Every MAC address is corresponding to a shopping profile, so that different shopping profiles are established respectively. In another embodiment, the customer database may be connected to a merchant checkout system. After the user finishes checkout, the merchant checkout system stores a trade record and coupon usage record of coupons of the user in the shopping profile in the customer database 130. The shopping profile may further comprises a contact information, personal information, personal picture, a habitual shopping time, a habitual moving trajectory, and a predicted shopping preference information. Wherein the contact information may include contact phone number, e-mail or community media; the personal information may include age, sexual, and birthday.

The preference learning module 140 is connected to the track database 120 and the customer database 130 to receive the moving trajectory 116 and the shopping profile of the user 1. The preference learning module 140 generates a suggested shopping preference information of the user 1 according to the moving trajectory 116 and the shopping profile. Wherein the predicted method of the preference learning module 140 can refer to the merchant recommend system behavior of online e-commerce system. The merchant recommend system of online e-commerce system can predict the item that customer prefers by collecting the mouse click history, webpage browsing history, and shopping cart history. Similarly, the preference learning module 140 can predict the item that customer prefers by physical shopping history. The preference learning module 140 may use supervised and unsupervised learning methods. The supervised learning method generates the predicted shopping preference information according to personal trade record, personal information, and ads accepted by the user 1. The unsupervised learning method generates the predicted shopping preference information according to the goods purchased by another user having similar habitual moving trajectory of the track database 120. The preference learning module 140 transmits the predicted shopping preference information to the personalized advertising module 150 and stores the predicted shopping preference information in the shopping profile.

Wherein, the preference learning module 140 is a machine learning or a deep learning of artificial intelligence computing system. The system has the ability to process and learn from the combination of different machine learning algorithms without specific ruled judgment logic.

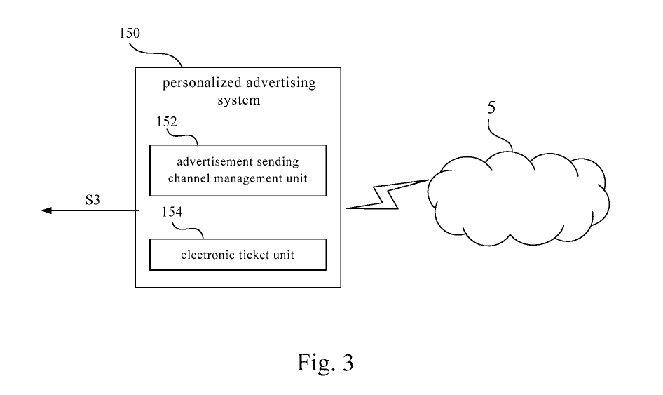

Please refer to FIG. 3. FIG. 3 shows a functional block diagram of the embodiment of the personalized advertising module 150 of the personalized advertising system 100 of the present invention. The personalized advertising module 150 sends a personalized advertisement to the mobile device 2 of the user 1 according to the predicted shopping preference information. In an embodiment, the personalized advertising module further comprises an advertisement sending channel management unit 152 and an electronic ticket unit 154. Wherein the advertisement sending channel management unit 152 obtains a social media often used by the user 1 via the shopping profile. And then the advertisement sending channel management unit 152 sends the personalized advertising message S3 to the user 1 via the social media. The electronic ticket unit 154 is connected to an electronic ticket database (not shown) via network 5. The electronic ticket unit 154 can obtain the information and shopping preference of the user 1 from the shopping profile. Next, the related electronic coupon in the electronic ticket database is selected according to the information and shopping preference. The personalized advertising message S3 comprising the related electronic coupon is sent to the user 1. The related electronic coupon includes the form of coupon, shopping voucher, or loyalty card. For example, if user 1 consumes on birthday, the electronic ticket unit 154 sends a personalized advertising message S3 of birthday coupon to user 1. After that, customer database 130 may further store the usage data of a consumer of using the related electronic coupon. The usage data can be used as a basis for analyzing the effectiveness of the electronic ticket.

In the above-mentioned embodiment, the personalized advertising system 100 generates the predicted shopping preference information of the user 1 by the preference learning module 140. Then, the personalized advertising module 150 sends a personalized advertising message S3 to the user 1 according to the predicted shopping preference information. The merchant checkout system stores the trade record and the coupon usage record of the user in the customer database 130. Along with the updating to the information in the customer database 130, the predicted shopping preference information generated by the preference learning module 140 optimizes as well. In practice, the preference learning module 140 may be calculated by decision tree, neural network, logistic regression, SVM, random forest, regression analysis, linear regression analysis, fuzzy matching, fuzzy search, or tensor flow.

In an embodiment of the present invention, the positioning device 110 further comprises an identification unit. The personalized advertising system 100 not only uses the MAC address of the user 1 to confirm the user identity, but also uses the identification unit for further identification. For example, the identification unit can comprise the camera and the image processing module coupled to the customer database 130. The identification unit confirms the user identity by image recognition according to the personal picture in the shopping profile. For instance, the MAC address of mobile device 2 carried by the user 1 is registered as a 30 year-old adult male. Sometimes this man identified by the identification unit was shopping with his kids. The moving trajectory of this man shows that he usually went toward to the toy area when shopping with his kids. Then the personalized advertising message S3 comprising personalized advertising related to toys is sent to the mobile device 2 of the user 1.

In another embodiment of the present invention, the wireless signal receiver 112 of the positioning device 110 can be deployed in the merchandise area. The wireless signal receiver 112 in the merchandise area receives the wireless signal S1 sent from the mobile device 2 of the user 1. The distance between the user 1 and the specific merchandise area is calculated from the signal strength indicator of the wireless signal S1 by the triangle positioning, cellular positioning, proximity, or other calculation methods. Then the user 1 is directed to the specified merchandise area. Wherein, the users 1 can install an application in the mobile device 2 of the user 1. The specified merchandise area can be defined by the user 1 through the application; or the specified merchandise area can be recommended by the personalized advertising message S3.

The wireless mobile communication protocols in the various embodiments described above are issued by the 3GPP Association. The protocols may be the version of Release 4, Release 5, Release 6, Release 7, Release 8, Release 9, Release 10, Release 11, Release 12, Release 13, Release 14, Release 15, or other mobile communication protocols approved by the International Telecommunication Union (ITU).

Compared to the prior art, the personalized advertising system of the present invention detects the customer activity in the store by the positioning device. Then the personalized advertising system selects the advertisement, the pushing channel and the electronic coupon by the preference learning module according to the track database and the customer database. The usage of electronic coupon consumption of the user will be fed back to the customer database. Therefore, the accuracy of the personalized advertising system of the present invention is optimized. Compared to the former physical marketing, the present invention collects the physical shopping habit of user and sends the advertisement that user may be interested in by a similar way of online marketing. The personalized advertising system is accurate as online marketing and leverages the advantage of physical marketing. At the same time, when the users receive the advertisement that they are interested in, the rejection that comes from advertising will reduce. Therefore, the intention of purchase will be enhanced.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A personalized advertising system, for sending a personalized advertisement to a mobile device when a user carries the mobile device into a space, comprising:
a positioning device, for receiving a wireless signal including a MAC address transmitted by the mobile device when the mobile device enters the space, wherein the positioning device obtains at least one position of the mobile device in the space according to the wireless signal, and calculates a moving trajectory according to the at least one position;
a track database, connected to the positioning device, for receiving and storing the moving trajectory calculated by the positioning device;
a customer database, connected to the positioning device, for storing the MAC address of the mobile device and a shopping profile corresponding to the MAC address;
a preference learning module, connected to the track database and the customer database, for receiving the moving trajectory and the shopping profile, and then generating a predicted shopping preference information of the user according to the moving trajectory and the shopping profile; and
a personalized advertising module, connected to the preference learning module, for receiving the predicted shopping preference information and sending a personalized advertising message to the mobile device of the user according to the predicted shopping preference information.

2. The personalized advertising system of claim 1, wherein the positioning device further comprises:
a plurality of wireless signal receiver, set up in the space respectively, for receiving the wireless signal and transmitting a wireless positioning signal respectively, wherein the wireless positioning signal comprises the MAC address of the wireless signal and a wireless signal intensity data of the wireless signal; and
a positioning server, for receiving the wireless positioning signals, and calculating the at least one position of the mobile device according to the set up position of the wireless signal receivers and the wireless positioning signals.

3. The personalized advertising system of claim 1, wherein the customer database is connected to a merchant checkout system, and the merchant checkout system stores a trade record and a coupon usage record of the user in the shopping profile of the customer database.

4. The personalized advertising system of claim 1, wherein the shopping profile further comprises at least one data selected from the following: a trade record, a coupon usage record, a contact information, a personal information, a personal picture, a habitual shopping time, a habitual moving trajectory, and a predicted shopping preference information.

5. The personalized advertising system of claim 1, wherein the preference learning module selects out from the other customers having the moving trajectory similar to the moving trajectory of the user in the track database, and sends a merchandise information bought by the other customers to the personalized advertising module and the personalized advertising module sends the advertisement related to the merchandise information.

6. The personalized advertising system of claim 1, wherein the positioning device further comprises an identification unit connected to the customer database, and the shopping profile of the customer database further comprises a personal picture, and the identification unit identifies the image of the user according to the personal picture in the shopping profile to confirm the user identity.

7. The personalized advertising system of claim 1, 2, 3, 4, 5, or 6, wherein the personalized advertising module further comprises an advertisement sending channel management unit, and the advertisement sending channel management unit obtains a social media often used by the user via the shopping profile, and then sends the personalized advertising message to the user via the social media.

8. The personalized advertising system of claim 1, 2, 3, 4, 5, or 6, wherein the personalized advertising module further comprises an electronic ticket unit, and the electronic ticket unit is informed of a shopping preference of the user via the shopping profile and sends the personalized advertising message comprising a related electronic coupon to the user.

9. The personalized advertising system of claim 8, wherein the shopping profile stored in the customer database further comprises a usage history of the related electronic coupon, and the customer database further stores a customer usage statistics data of the related electronic coupon.

10. The personalized advertising system of claim 1, 2, 3, 4, 5, or 6, wherein the preference learning module can be implement through one of the following method: Decision Tree, Neural Network, Logistic Regression, SVM, Random Forest, Regression Analysis, Linear Regression Analysis, Fuzzy Matching, Fuzzy Search, TensorFlow or the combination thereof.

11. The personalized advertising system of claim 1, or 2, wherein the positioning method of the positioning device is selected at least one positioning technology from the following: infrared positioning technology, ultrasonic positioning technology, RFID positioning technology, Bluetooth positioning technology, Wi-Fi positioning technology, ZigBee positioning technology, ultra wideband positioning technology, or GPS positioning technology.

12. The personalized advertising system of claim 1, or 2, wherein the positioning device calculates the distance between the user and a merchant in an area through triangle positioning, cellular positioning, proximity, or other calculation methods.

13. The personalized advertising system of claim 12, wherein the personalized advertising module automatically sends a personalized advertisement according to the predicted shopping preference information, and the personalized advertisement comprises the information to guide the user to the merchant in the area.
